(19) United States
(12) Patent Application Publication
(10) Pub. No.: US 2014/0179473 A1
(43) Pub. Date: Jun. 26, 2014

(54) CHAIN GUIDE

(71) Applicant: TSUBAKIMOTO CHAIN CO., Osaka (JP)

(72) Inventors: Masahiko Konno, Osaka-shi (JP); Yuichiro Ishikawa, Osaka-shi (JP); Takahiro Matsushita, Osaka-shi (JP)

(73) Assignee: TSUBAKIMOTO CHAIN CO., Osaka (JP)

(21) Appl. No.: 14/140,286

(22) Filed: Dec. 24, 2013

(30) Foreign Application Priority Data
Dec. 25, 2012 (JP) 2012-280580

(51) Int. Cl. F16H 7/18

(52) U.S. Cl. CPC F16H 7/18
USPC 474/140

(57) ABSTRACT

The invention provides a chain guide capable of reducing a space the guide occupies in an engine room while maintaining necessary strength, rigidity, and durability with a simple configuration, reducing manufacturing man-hour and a waste of a material, preventing an increase in vibration and noise during use without necessity of forming a structure for allowing an error, and reducing a maintenance work load. A chain guide includes a guide shoe and a base member configured to support the guide shoe. The base member includes a base attaching section extending perpendicularly to a chain traveling direction. The guide shoe includes a guide shoe attaching section extending perpendicularly to the chain traveling direction in a position spaced apart from the base attaching section in the chain traveling direction.

### BACKGROUND OF THE INVENTION

1. Field of the Invention

The present invention relates to a chain guide including a guide shoe configured to slide and guide a traveling chain and a base member configured to support the guide shoe along a chain traveling direction.

2. Description of the Related Art

In order to stabilize a chain traveling between sprockets and properly retain tension, a chain guide including a guide shoe configured to slide and guide the traveling chain has been used in common.

For example, a timing system for an engine is publicly known that drives a driving chain CH such as a roller chain endlessly wound between sprockets S1 and S2 respectively provided in a crank shaft and a cam shaft in an engine room E as shown in FIG. 5. The timing chain CH is endlessly wound between a driving sprocket S1 attached to the crank shaft and a pair of driven sprockets S2 attached to the cam shaft in the engine room E. The timing chain CH is guided by a swinging guide G and a chain guide 500 (a fixed guide).

In the publicly-known timing system, the chain guide 500 is fixed in the engine room E by two attachment shafts B1 and B2. The swinging guide G is attached in the engine room E to be capable of swinging in a winding plane of the timing chain CH around a swinging shaft B0.

A chain tensioner T presses the swinging guide G to properly retain the tension of the timing chain CH and suppress vibration of the timing chain CH.

In a chain guide used in such a publicly-known timing system, a traveling guide section is desirably formed of a low-friction material resistive to wear. A chain guide entirely formed of a low-friction resin material is publicly known.

However, a chain guide on a fixed side requires certain degrees of strength, rigidity, and durability in order to stably guide a change against the tension and the vibration of the chain. When the chain guide is formed of only a resin material, in order to obtain the necessary strength, rigidity, and the durability, the thickness of the material need to be increased. Therefore, the chain guide occupies a large space in an engine room.

Therefore, a chain guide is publicly known in which only a traveling guide section is formed of a low-friction resin material, which is configured to be supported by a material having large strength, rigidity, and durability such as metal, thereby reducing a space occupied by the chain guide while securing strength, rigidity, and durability necessary for the entire chain guide (see Japanese Patent Application Laid-Open No. H10-89428).

For example, the publicly-known chain guide 500 includes, as shown in FIGS. 6 to 8, a guide shoe 510 made of resin configured to slide and guide a traveling chain and a base member 520 made of metal configured to support the guide shoe 510 along a chain traveling direction.

The base member 520 includes a shoe supporting section 521 extending in the chain traveling direction and base attaching sections 522 respectively extending vertically in positions spaced apart from each other in the chain traveling direction. The base member 520 is formed by bending an integral metal plate at 90° in two places to form the base attaching sections 522 to be perpendicular to the shoe supporting section 521.

Attachment holes 523, through which bolts or the like are inserted, are respectively provided in the base attaching sections 522 in the two places.

The guide shoe 510 is configured to be capable of being fitted with and unfitted from the base member 520 when the traveling guide section 511 is supported by the shoe supporting section 521 of the base member 520 and end locking pieces 512 at both ends in the chain traveling direction and a plurality of side locking pieces 513 provided in appropriate parts in the width direction are locked to the shoe supporting section 521.

In such a publicly-known chain guide, the base member 520 is formed by bending the integral metal plate at 90° in the two places to form the shoe supporting section 521 and the base attaching sections 522 in the two places. Therefore, bending for the two places is necessary and manufacturing man-hour increases.

A large amount of metal material is necessary because the shoe supporting section 521 and the base attaching sections 522 in the two places are formed of the integral metal plate. When the shoe supporting section 521 and the base attaching sections 522 are manufactured from one metal plate by punching or the like, since the shoe supporting section 521 and the base attaching sections 522 are formed in a shape profile having large number of projecting sections, a waste of the material increases.

Further, a dimension error between a space between the attachment holes 523 of the base attaching sections 522 in the two places and a space between fixed sections on an engine inner side is inevitable in manufacturing. The spaces increases or decreases according to temperature. Therefore, in order to attach the chain guide while allowing the error, such an attachment structure needs to be formed in a structure for allowing a very small error. Specifically, at least one of the attachment holes 523 needs to be formed as a long hole.

This is the same in other publicly-known chain guides including attaching sections in two or more places such as the chain guide entirely formed of the low-friction resin material explained above.

When a bolt or the like is inserted through the attachment hole formed as the long hole for allowing a very small error and the chain guide is fixed, a fixture such as the bolt slightly moves in the long hole according to a difference between expansion and contraction amounts of the chain guide and an engine block due to a temperature change during use and a tension change and vibration of the chain. Therefore, when the chain guide is used for a long period, the fixing is loosened to cause an increase in vibration and noise. In the worst case, the chain guide drops into the engine room. To reduce this problem, the frequency of maintenance work needs to be increased.

### SUMMARY OF THE INVENTION

The present invention solves the problems by providing, in a chain guide including a plurality of members and fixed by a plurality of attaching sections, the plurality of attaching sections are provided in the plurality of members in a distributed manner rather than being provided in one member. It is an object of the present invention to provide a chain guide capable of reducing a space this guide occupies in an engine room while maintaining necessary strength, rigidity, and durability with a simple configuration, reducing manufacturing man-hour and a waste of a material, preventing an increase in vibration and noise during use without necessity of forming a structure for allowing an error, and reducing a maintenance work load.

The present invention provides a chain guide including: a guide shoe configured to slide and guide a traveling chain; and a base member configured to support the guide shoe along a chain traveling direction. The base member includes: a shoe supporting section extending in the chain traveling direction; and a base attaching section extending perpendicularly to the chain traveling direction. The guide shoe includes: a traveling guide section extending in the chain traveling direction; and a guide shoe attaching section extending perpendicularly to the chain traveling direction in a position spaced apart from the base attaching section in the chain traveling direction. Consequently, the present invention solves the problems.

With the chain guide according to claim 1, it is possible to reduce a space the chain guide occupies by forming the base member contributing to strength, rigidity, and durability from a material different from the material of the guide shoe. Since the base member includes the base attaching section only in one place, it is possible to reduce machined parts of the base member and reduce a waste of a material.

The base member and the guide shoe are respectively separately fixed in the base attaching section and the guide shoe attaching section. Consequently, even if each of the base member and the guide shoe expands or contracts because of a temperature change or is deformed by a tension change, vibration, or the like of the chain, it is possible to always keep a space between the base attaching section and the guide shoe attaching section the same as a space on a fixed side of an engine or the like.

Therefore, both of the base attaching section and the guide shoe attaching section do not need to be formed in an attachment structure for allowing a very small error. Even if a difference between expansion and contraction amounts due to a temperature change during use or deformation due to a tension change or vibration of the chain occurs, displacement does not occur in both the attaching sections. Therefore, the fixing is not loosened even if the chain guide is used for a long period. It is possible to prevent an increase in vibration and sound during use and reduce a maintenance work load.

With a configuration described in claim 2, it is possible to reduce the friction of a traveling guide section and molding is facilitated by forming the guide shoe from a synthetic resin material. Further, it is possible to sufficiently secure strength, rigidity, and durability while reducing a space the guide occupies by forming the base member from a metal material.

With a configuration described in claim 3, it is possible to form the base member from a metal plate by punching or the like and form the base attaching section by bending the base member. Therefore, manufacturing is facilitated.

With a configuration described in claim 4, the guide shoe and the base member are configured to be capable of being fitted with and unfitted from each other. Therefore, manufacturing by assembly is facilitated, it is possible to replace the guide shoe and the base member in units of the members during maintenance after use, maintenance work is also facilitated, and costs are reduced.

With a configuration described in claim 5, it is possible to arbitrarily set the space between the base attaching section and the guide shoe attaching section, it is possible to easily absorb an error between the space and a dimension of a part to which an engine or the like is fixed, and attachment work is facilitated.

When the base member and the guide shoe expands or contracts because of a temperature change or is deformed by a tension change, vibration, or the like of the chain, it is possible to allow a force applied in the chain traveling direction to escape by relatively displacing the force. Since concentrated stress is not applied to a specific part, it is possible to further improve durability.

Further, since concentrated stress is not applied to the base attaching section and the guide shoe attaching section either, it is possible to surely prevent the fixing from being loosened, prevent an increase in vibration and noise during use, and reduce a maintenance work load.

### BRIEF DESCRIPTION OF THE DRAWINGS

FIG. 1 is a top perspective view of a chain guide according to a first embodiment of the present invention;

FIG. 2 is a bottom perspective view of the chain guide according to the first embodiment of the present invention;

FIGS. 3A to 3C are respectively a plan view, a front view, and a bottom view of the chain guide according to the first embodiment of the present invention;

FIGS. 4A to 4E are schematic explanatory diagrams of chain guides according to other embodiments of the present invention;

FIG. 5 is an explanatory diagram of a timing system of a conventional engine;

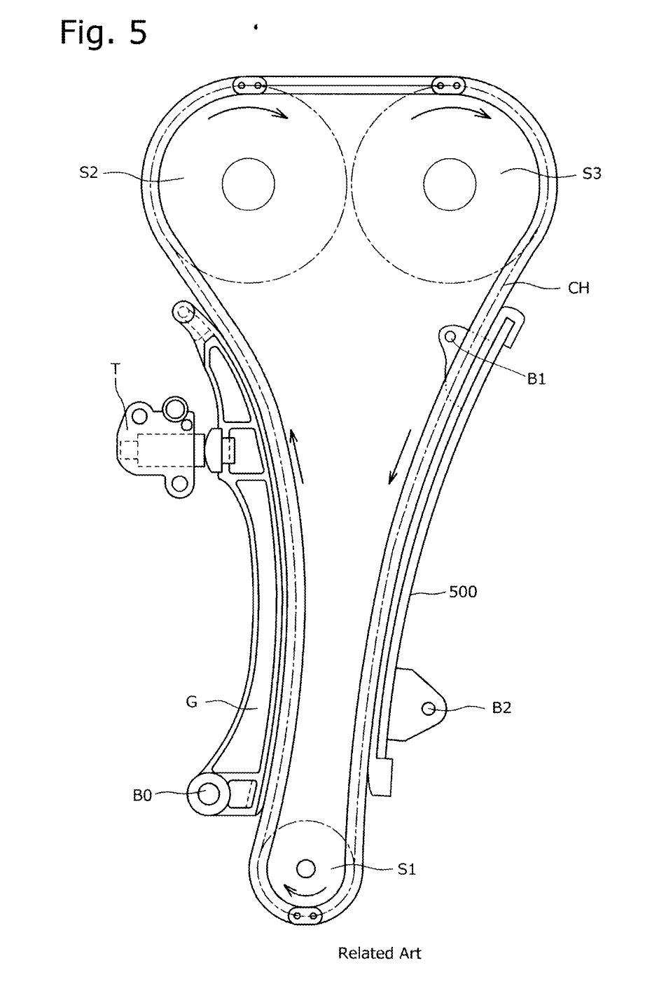

FIG. 6 is a top perspective view of a conventional chain guide;

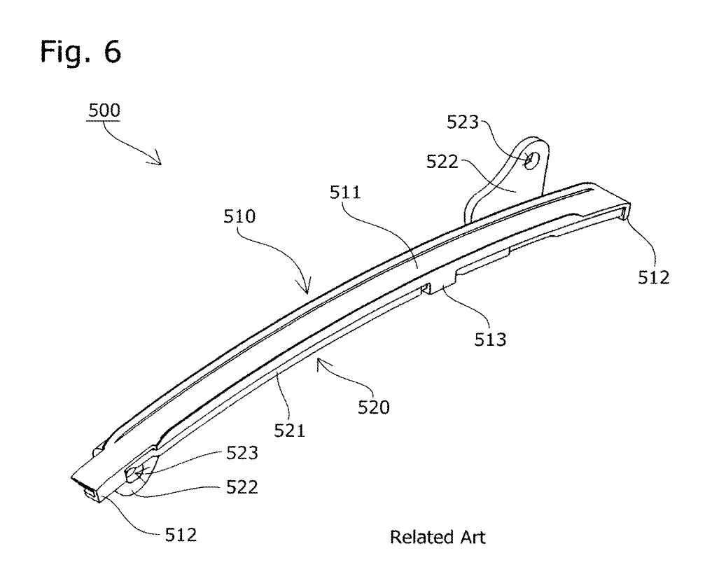

FIG. 7 is a bottom perspective view of the conventional chain guide; and

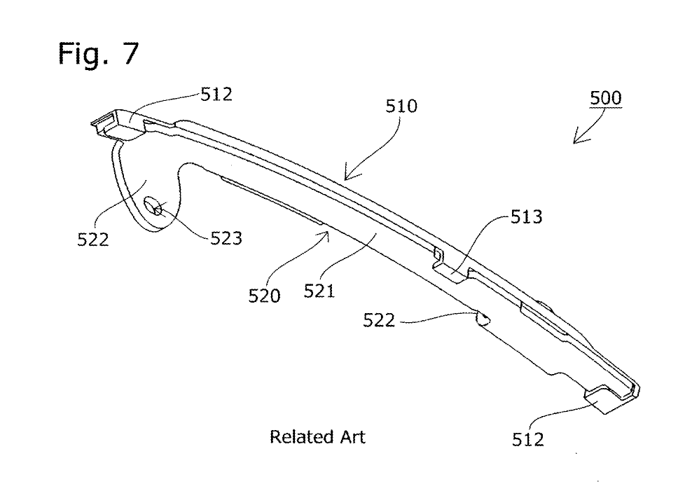

FIGS. 8A to 8C are respectively a plan view, a front view, and a bottom view of the conventional chain guide.

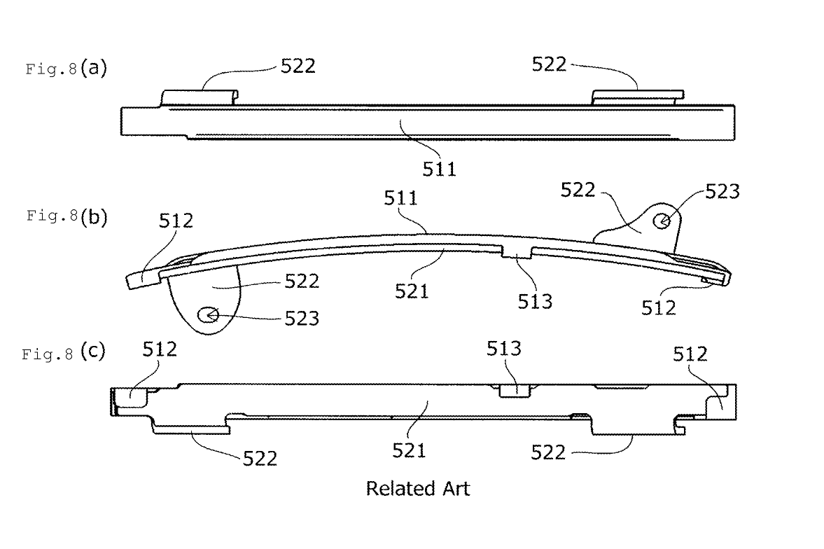

### DESCRIPTION OF THE PREFERRED EMBODIMENT

The present invention is based on the technical idea that, when a chain guide includes a plurality of members and is fixed by a plurality of attaching sections, the plurality of attaching sections are provided in the plurality of members in a distributed manner rather than being provided in one member. The present invention provides a chain guide including a guide shoe configured to slide and guide a traveling chain and a base member configured to support the guide shoe along a chain traveling direction. The base member includes a shoe supporting section extending in the chain traveling direction and a base attaching section extending perpendicularly to the chain traveling direction. The guide shoe includes a traveling guide section extending in the chain traveling direction and a guide shoe attaching section extending perpendicularly to the chain traveling direction in a position spaced apart from the base attaching section in the chain traveling direction. The specific configuration of the chain guide may be any configuration as long as the chain guide is capable of reducing a space the guide occupies in an engine room while maintaining necessary strength, rigidity, and durability with a simple configuration, reducing manufacturing man-hour and a waste of a material, preventing an increase in vibration and noise during use without necessity of forming a structure for allowing an error, and reducing a maintenance work load.

The base member is desirably a metal material. It is particularly suitable to manufacture the base member from a rolled steel plate. However, a publicly-known appropriate metal material only has to be selected according to various conditions such as rigidity, durability, moldability, and costs.

The material of the guide shoe is desirably synthetic resin. However, a publicly-known appropriate material only has to be selected according to various conditions such as frictional resistance, rigidity, durability, moldability, and costs.

### EMBODIMENTS

A chain guide 100 (a fixed guide) according to a first embodiment of the present invention is explained based on the drawings.

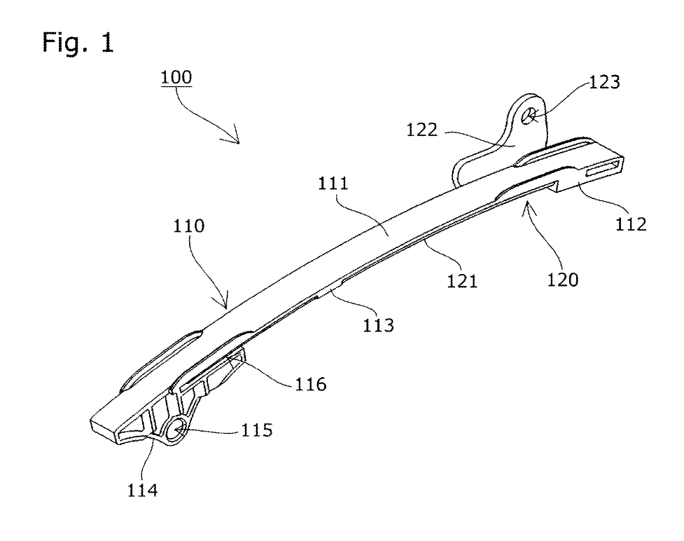

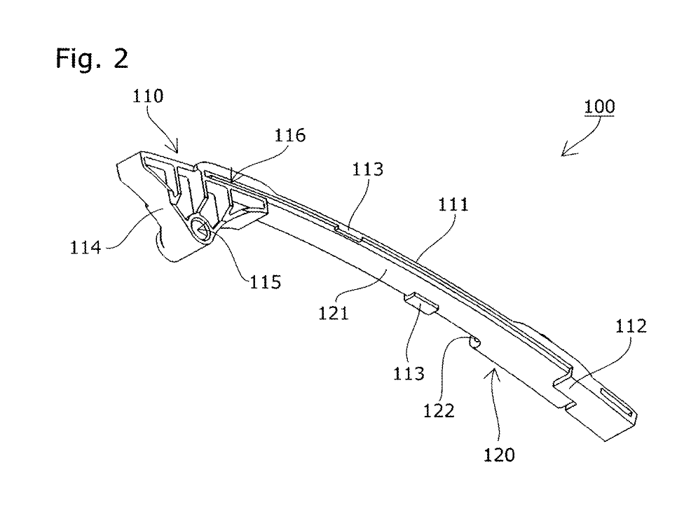

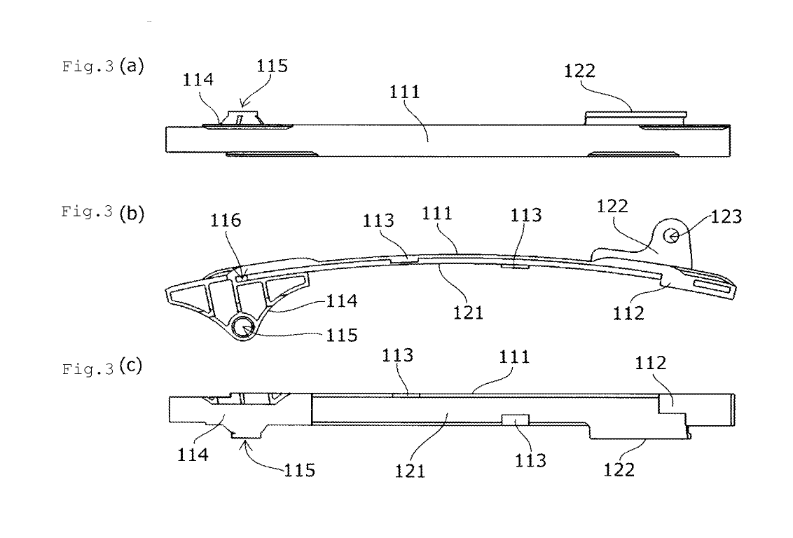

The chain guide 100 is applied to the publicly-known timing system explained above. As shown in FIGS. 1 to 3, the chain guide 100 includes a guide shoe 110 configured to slide and guide a traveling chain and a base member 120 configured to support the guide shoe 110 along a chain traveling direction.

The base member 120 includes a shoe supporting section 121 extending in the chain traveling direction and a base attaching section 122 extending perpendicularly to the chain traveling direction. The base member 120 is formed by punching one rolled steel plate and then bending the base attaching section 122 at 90° with respect to the shoe supporting section 121.

A predetermined curved shape is given to the shoe supporting section 121 along the chain traveling direction.

The guide shoe 110 includes a traveling guide section 111 extending in the chain traveling direction and a guide shoe attaching section 114 extending perpendicularly to the chain traveling direction in a position spaced apart from the base attaching section 122 in the chain traveling direction. The guide shoe 110 is integrally molded from a synthetic resin material by, for example, injection molding.

The guide shoe attaching section 114 is formed to extend to a rear surface side on a downstream side of the traveling guide section 111. An attachment hole 115, through which a bolt or the like for fixing the guide shoe attaching section 114 in an engine room is inserted, is provided in the guide shoe attaching section 114. The guide shoe attaching section 114 is reinforced by a rib in order to secure strength and rigidity.

A fitting groove 116, in which the shoe supporting section 121 of the base member 120 can be inserted and fit, is provided in the guide shoe attaching section 114. Side locking pieces 113 engaging with sides in the width direction of the shoe supporting section 121 and an end locking piece 112 engaging with an upstream side end of the shoe supporting section 121 are provided on the rear surface side of the traveling guide section 111. The guide shoe 110 and the base member 120 are configured to be capable of being fitted with and unfitted from each other displaceably in the chain traveling direction in a state in which the base member 120 supports the rear surface of the guide shoe 110.

In this embodiment, the right direction in FIGS. 1 to 3 is set as an upstream side in the chain traveling direction, the left direction in FIGS. 1 to 3 is set as a downstream direction in the chain traveling direction, a chain traveling surface side of the traveling guide section 111 is set as a front surface side, and an opposite surface side of the chain traveling surface side is a rear surface side.

In this embodiment, the side locking pieces 113 are provided in two places. One is formed in a hook shape reaching from one side surface to the rear surface side of the shoe supporting section 121. The other is formed in a shape for pressing only the other side surface of the shoe supporting section 121. However, the side locking pieces 113 only have to be provided in an appropriate number, an appropriate shape, and appropriate positions taking into account, for example, easiness of attachment and detachment during assembly and during maintenance as long as the side locking pieces 113 can surely maintain a fitting state even during use.

Cutouts may be provided as appropriate in positions on the sides of the shoe supporting section 121 where the side locking pieces 113 engage. In that case, the length in the chain traveling direction of the cutouts only has to be designed larger than the length of the side locking pieces 113 by assumed displacement in the chain traveling direction of the guide shoe 110 and the base member 120.

With the chain guide 100 according to this embodiment configured as explained above, the guide shoe 110 made of low-friction synthetic resin is configured to be supported by the base member 120 made of metal that contributes to strength, rigidity, and durability. Therefore, it is possible to reduce a space the guide occupies in the engine room in which the chain guide 100 is fixed. Since the base attaching section 122 of the base member 120 is provided only in one place, it is possible to reduce machined parts of the base member 120 and manufacturing is facilitated. Further, it is possible to reduce a waste of a material of an expensive rolled steel plate and costs are reduced.

The guide shoe 110 and the base member 120 are configured to be fitted with and unfitted from each other displaceably in the chain traveling direction in a state in which the base member 120 supports the rear surface of the guide shoe 110. The base member 120 and the guide shoe 110 are respectively separately fixed by the base attaching section 122 and the guide shoe attaching section 114. Therefore, even if each of the base member 120 and the guide shoe 110 expands or contracts because of a temperature change or is deformed by a tension change, vibration, or the like of the chain, it is possible to always keep a space between the base attaching section 122 and the guide shoe attaching section 114 the same as a space on a fixed side of an engine or the like.

Therefore, both of the base attaching section 122 and the guide shoe attaching section 114 do not need to be formed in an attachment structure for allowing a very small error. The respective attachment holes 123 and 115 may be round holes. Even if a difference between expansion and contraction amounts due to a temperature change during use or deformation due to a tension change or vibration of the chain occurs, displacement does not occur in both of the base attaching section 122 and the guide shoe attaching section 114. Therefore, the fixing is not loosened even if the chain guide 100 is used for a long period. It is possible to prevent an increase in vibration and sound during use and reduce a maintenance work load.

In the embodiment, the guide shoe attaching section 114 is provided on the rear surface side on the downstream side of the guide shoe 110. The base attaching section 122 is provided on the front surface side on the upstream side of the base member 120. However, as long as the guide shoe attaching section 114 and the base attaching section 122 are separated from each other in the chain traveling direction, whichever of the guide shoe attaching section 114 and the base attaching section 122 may be provided on the upstream side or both of the guide shoe attaching section 114 and the base attaching section 122 may be the front surface side or the rear surface side.

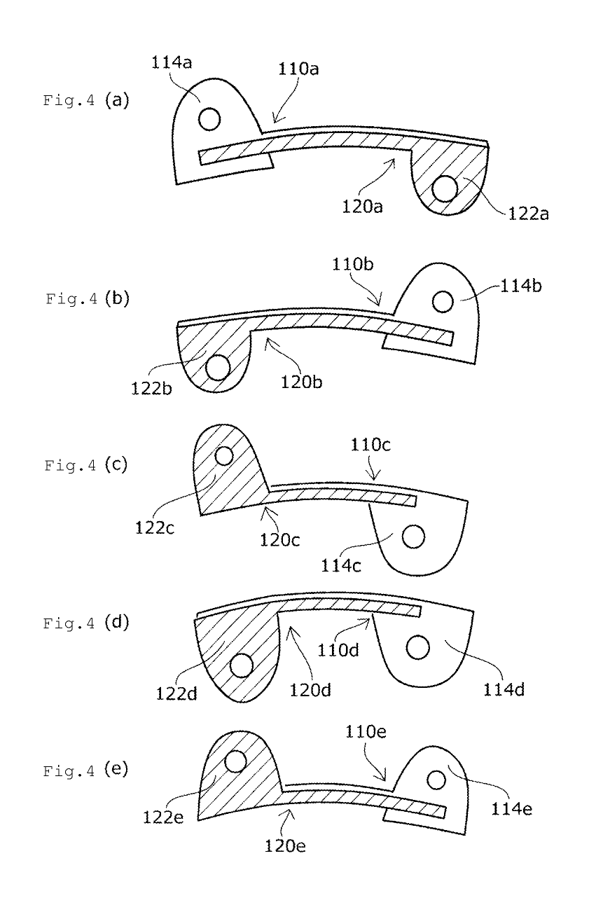

That is, in other embodiments, chain guides maybe configured as explained below. As shown in FIG. 4A, a guide shoe attaching section 114a is provided on the front surface side on the downstream side of a guide shoe 110a and a base attaching section 122a is provided on the rear surface side on the upstream side of a base member 120a. As shown in FIG. 4B, a guide shoe attaching section 114b is provided on the front surface side on the upstream side of a guide shoe 110b and a base attaching section 122b is provided on the rear surface side on the downstream side of a base member 120b. As shown in FIG. 4C, a guide shoe attaching section 114c is provided on the rear surface side on the upstream side of a guide shoe 110c and a base attaching section 122c is provided on the front surface side on the downstream side of a base member 120c. As shown in FIG. 4D, a guide shoe attaching section 114d is provided on the rear surface side on the upstream side of a guide shoe 110d and a base attaching section 122d is provided on the rear surface side on the downstream side of the base member 120d. As shown in FIG. 4E, a guide shoe attaching section 114e is provided on the front surface side on the upstream side of a guide shoe 110e and a base attaching section 122e is provided on the front surface side on the downstream side of the base member 120e. The upstream side and the downstream side in FIGS. 4D and 4E may be opposite (the left and the right in the figures may be opposite).

The embodiments explained above are specific examples of the chain guide according to the present invention. However, the chain guide according to the present invention is not limited to these embodiments. Various modifications are possible concerning shapes, positions, dimensions, arrangement relations, and the like of the components.

For example, in the embodiments, as shown in FIGS. 1 to 3A to 3C, lips for regulating movement in the width direction of the chain are provided on both sides near the base attaching section 122 and the guide shoe attaching section 114 on the surface of the traveling guide section 111. However, the lips may be provided in other positions. The height, the length in the chain traveling direction, and a set number of the lips may be any height, length, and number. The lips may be continuously provided over the entire chain traveling direction.

In the embodiments, the chain guide is provided in the engine including the timing system. However, the chain guide is not limited to this and can be applied to various machines.

The chain guide is not limited to the driving mechanism by the chain and may be applied to similar driving mechanisms such as a belt and a rope. The chain guide can be used in various industrial fields.

What is claimed is:

1. A chain guide comprising:
a guide shoe configured to slide and guide a traveling chain; and
a base member configured to support the guide shoe along a chain traveling direction, wherein
the base member is formed of:
a shoe supporting section extending in the chain traveling direction; and
a base attaching section extending perpendicularly to the chain traveling direction, and
the guide shoe is formed of:
a traveling guide section extending in the chain traveling direction; and
a guide shoe attaching section extending perpendicularly to the chain traveling direction in a position spaced apart from the base attaching section in the chain traveling direction.

2. The chain guide according to claim 1, wherein
the guide shoe is formed of a synthetic resin material, and
the base member is formed of a metal material.

3. The chain guide according to claim 2, wherein
the base member is configured by an integral metal plate, and
the base attaching section is formed to be bent at 90° with respect to the shoe supporting section.

4. The chain guide according to claim 1, wherein the guide shoe and the base member are configured to be capable of being fitted with and separated from each other.

5. The chain guide according to claim 1, wherein the guide shoe and the base member are fitted with each other displaceably in the chain traveling direction.
